(19) United States
(12) Patent Application Publication
(10) Pub. No.: US 2015/0154878 A1
(43) Pub. Date: Jun. 4, 2015

(54) Intelligent Adaptive Integrated Learning Environment

(71) Applicant: The Trustees of The Stevens Institute of Technology, Hoboken, NJ (US)

(72) Inventors: Alexei Miasnikov, West Milford, NJ (US); Alexey Myasnikov, Brooklyn, NY (US)

(21) Appl. No.: 14/559,279

(22) Filed: Dec. 3, 2014

Related U.S. Application Data
(60) Provisional application No. 61/911,628, filed on Dec. 4, 2013.

(51) Int. Cl. G09B 7/00

(52) U.S. Cl. CPC G09B 7/00

(57) ABSTRACT

An intelligent adaptive integrated learning environment to optimize the learning process to a particular user. The environment is capable of providing assessment and targeted feedback.

### CROSS REFERENCE TO RELATED APPLICATION

This application claims the benefit of U.S. Provisional Application No. 61/911,628, filed Dec. 4, 2013, which is incorporated by reference herein in its entirety.

### FIELD OF THE INVENTION

The present invention relates to learning and assessment environments and, more particularly, to adaptive computer-based learning and assessment environments also known as distance learning environments.

### BACKGROUND OF THE INVENTION

Computer-based learning is used as a supplement to modern education as it provides a user with access to vast stores of knowledge and learning materials virtually instantaneously. However, a major drawback is that computer-based learning is not capable of adequate adaptation in a way that optimizes the learning process. Such learning generally utilizes the “teach by example” methodology which requires that a user complete a large amount of problems and read the corresponding solutions. These problems are not tailored to a particular user's learning process. While there have been attempts to remedy this problem, there has yet to be a successful environment that is adequately adaptive to the user's learning style. Thus, it is an objective of the present invention to provide an adaptive learning environment that is capable of optimizing the learning process.

### SUMMARY OF THE INVENTION

In an embodiment, the present invention is a system for distance learning based on an integrated environment that intertwines various basic elements of learning into a single framework equipped with a package of algorithms that continuously monitor a student's learning process. Additionally, these algorithms assess the student's current knowledge and progress, guide the student through the material in the most efficient way as adjusted to the goals of such individual student, and report the results to the student and the instructor.

In an embodiment, the idea of the Integrated Learning Environment (ILE) is to integrate all known basic elements of learning and teaching into a single, highly interlinked system equipped with a user interface and a library of algorithms that continuously monitor, assess and guide the student through his or her learning process. The basic elements, or content elements, are indivisible atoms of the environment that occur in the most basic, elementary interactions of the user with the system. These include pieces of an electronic document, pieces of a video, problems and the logical steps in their solutions, questions and their answers, etc. All of these elements are interlinked into a single environment, so the student can move from one element to another along the links using the system interface. The interlinked elements can be viewed as a directed graph.

In an embodiment, the elementary act of learning by the student is an interaction with a particular element, such that the learning process can be depicted as a sequence of elementary learning interactions or a sequence of steps in the underlying graph (i.e., a particular path in the graph). The back-end algorithms record all of the learning steps made by the student, as well as the outcomes of the elementary interactions with the elements. These outcomes could be of two types: assessment outcomes and informational outcomes. In the assessment outcomes (for example, advancing one step in the solution of a problem, interacting with an automated tutor, or answering a question), the outputs allow one to measure the student's knowledge of the subject. On the other hand, informational outcomes occur when the student is watching a video, reading a text, etc. The outcome is that the student has observed, or triggered, this particular element.

In an embodiment, the current record of the learning path of the student equipped with all of the elementary outcomes obtained up to a given point constitutes all of the data accumulated on the learning process of the student at that given point. The mathematical algorithms analyze this data and give an instant assessment of the current knowledge of the student, determine the exact location where a mistake was made, if any, and of what kind, and suggest the optimal way to proceed in the learning process, i.e., recommend the next step(s) (elementary interaction(s)) in the graph. These algorithms are based on various machine learning and statistical pattern recognition techniques.

In an embodiment, there are auxiliary algorithms and tools in the system which enable visualization of the current progress of the student which includes, for example, instructor tools, communication tools, special learning tools (for example, the model builder or computational packages), etc. For convenience of representation and to make understanding of the system easier, the Integrated Learning Environment is divided into several major blocks or components: Hypercontent, Automated Tutor, Problem Solving, Instant Response System, Model Building, Student Profile, Instructor's Tools, Library of Assessing, Monitoring, and Guiding Algorithms (see FIG. 1).

Additionally, in an embodiment, the present invention provides: integration of the content elements into a highly interlinked system; an interface allowing elementary interaction of the student with elements of the system; continuous monitoring and recording of each interaction made by the student and the respective outcomes; and instant assessment of the student's understanding of the material. In an embodiment, the present invention accomplishes this by employing, in no particular order: division of standard electronic documents, videos, images, problems, solutions of problems, questions and their answers, etc, into atomic elements, or so-called content elements; associating outcomes with each interaction, such outcomes being of two types: assessing and informational; interpretation of the student's learning process as a directed sequence of elementary interactions, i.e., a path in the system (which is viewed as a graph) equipped with all of the outcomes of the interactions; and guidance of the learning process of each student based on monitoring, assessment, and the student profile.

In another embodiment, a method for providing an adaptive learning environment to a person includes providing a database of knowledge content elements; interlinking the content elements, forming a traversable data structure; presenting at least one of the content elements to the person, thereby defining an informative element; recording the presentation of the informative element to the person, thereby creating a record of informative elements that the person has been exposed to.

In another embodiment, the traversable data structure may be modeled by a directed graph.

In another embodiment, an order of presentation during the step of presenting is determined by at least a portion of the directed graph.

In another embodiment, the interlinked content elements include assessment elements that may be presented to the person in a problem/solution relationship, whereby traversal of a given set of assessment elements may test the knowledge of the person.

In another embodiment, further including the steps of assessing the assimilation of the informative element presented to the person by the person by presenting at least one assessment element and recording the assessment element presented and a response by the person thereto.

In another embodiment, the person's response is assessed as accurate or not and the assessment recorded to provide insight into the progress of the person in assimilating knowledge presented.

In another embodiment, the person's responses are evaluated for accuracy and further comprising the step of presenting content elements to the person responsive to the assessment and in the case of inaccurate responses, presenting remedial content elements.

In another embodiment, the knowledge content elements are derived from at least one of documents, videos or images.

In another embodiment, the content elements are at least one of a video, a portion of a video, a paragraph, a sentence, a formula, a definition, an image, a portion of an image, a step in a solution of a problem or an instant response question.

In another embodiment, outcomes of the assessment elements are a numerical score.

In another embodiment, outcomes of the assessment elements are categorical.

In another embodiment, outcomes of the assessment elements include the assessment “unknown” to indicate that an assessment element has not been triggered yet.

In another embodiment, the method is implemented on a programmable computer system with digital storage for storing the database of knowledge elements, a processor for executing the steps of the method and input and output devices supporting communication between the person and the system and wherein I={i₁, . . . , iₙ} is the set of all information elements and A={a₁, . . . , aₘ} the set of all assessment elements and a state of the system is the set S, S={I₁, . . . , Iₙ, A₁, . . . , Aₘ}, where Iₖ is the number of times an information element iₖ was observed during a run of the system and Aⱼ is the value of the outcome of a particular assessment element and wherein every time a value of an element of S is changed, the system makes a transition into another state, which may have previously been observed, given a particular state S of a system run, an objective function F(S)≧0 may be defined which corresponds to the progress of a student (i.e., an amount of knowledge or mastered subjects).

In another embodiment, further including the steps of maximizing F(S) probabilistically by defining T(e) as the event that an element e∈ε=IU A triggers, assuming it is impossible to execute two or more events simultaneously implying that the movement from state S to another state Q can be accomplished by triggering only one event T(e) and, therefore, the transition probability is Pr(Q|S)=Pr(T(e)|S), for some element e; executing a random walk search algorithm on the space of system states guided by probabilities Pr(T(e)|S), e∈ε to find an optimal distribution which allows the maximization of F(S) in the most efficient way possible.

In another embodiment, F(S) is determined by summing normalized outcomes of the assessment elements.

In another embodiment, further including the step of obtaining an initial state for the system by performing a placement test.

In another embodiment, further including the step of obtaining an initial state for the system by setting the probabilities of a subset of information elements to non-zero values.

In another embodiment, further including the step of observing the interaction of a plurality of persons to ascertain behavioral patterns and using the behavioral patterns to guide the presentation of content elements.

In another embodiment, further including the step of ascertaining groups of like persons based upon a similarity in behavior patterns and using group behavior patterns to guide the presentation of content elements.

In another embodiment, a computer readable media has digital information thereon suitable for programming a computer to perform the above-described method.

### BRIEF DESCRIPTION OF FIGURE

FIG. 1 is a diagram that depicts the components of an integrated learning environment according to an embodiment of the present invention.

### DETAILED DESCRIPTION OF THE INVENTION

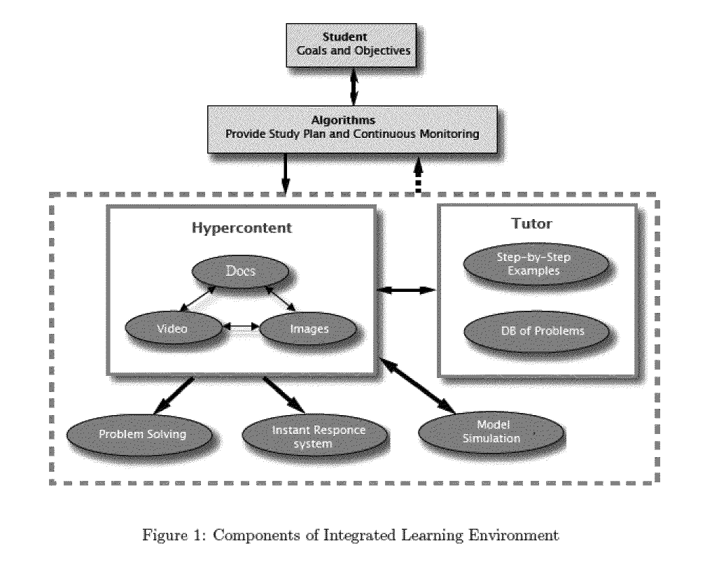

The internal representation and possible organization of the continuous monitoring, assessment and guidance of a student will now be described with reference to FIG. 1. All components of the environment are split, or organized, into content elements. These are indivisible pieces of content which occur in elementary interactions of the user with the system. Examples of such elements are: a small logically complete video or part of a video; a paragraph or a sentence in a text, a formula, a definition, etc.; an image or part of an image; elements that appear in a single interaction between the user and the system in the tutor mode; a rewrite or a logical step in a solution of an exercise or a problem; and an instant response question.

These elements can be divided into two categories: informative elements and assessment elements. The main difference between the two is that the only thing that can be obtained from informative elements is knowledge that the user had observed them. Assessment elements allow more outcomes in the interaction with the user such as a correct or incorrect answer to a question, a correctly applied formula, a logical step made in the proper location, an expected data distribution in the simulation, and so on.

Now, let I={i₁, . . . , iₙ} be the set of all information elements and A={a₁, . . . , aₘ} be the set of all assessment elements. A state of the system is the set S, as follows:

S={I₁, . . . , Iₙ, A₁, . . . , Aₘ},

where Iₖ is the number of times an information element iₖ was observed during the run and Aⱼ is the value of the outcome of a particular assessment element.

Outcomes of the assessment elements can be numerical (for example, a partial credit) or categorical (for example, “YES”/“NO”). It is also useful to have a special outcome “unknown” to indicate that an assessment element has not been triggered yet.

Every time a value of an element of S is changed, the system makes a transition into another state, which may have previously been observed. Such a transition may be termed an elementary transition.

Given a particular state S of a system run, an objective function F(S)≧0 may be defined which corresponds to the progress of a student (i.e., an amount of knowledge or mastered subjects). One choice of objective function would be to sum up all normalized outcomes of the assessment elements. Other related objective functions may also be used. For example, in knowledge spaces, it is desired to maximize the set of mastered knowledge elements, and the corresponding function can be computed from a set of assessment components disregarding information elements.

The whole interaction process between the system and the user can then be viewed as a search problem on the space of all possible states of the system with an objective to maximize the function F(S). This process may best be viewed in terms of probabilities.

Let T(e) be the event that an element e∈ε=IU A is triggered. It was assumed that it is impossible to execute two or more events simultaneously. This implies that the movement from state S to another state Q can be accomplished by triggering only one event T(e) and, therefore, the transition probability is:

Pr(Q|S)=Pr(T(e)|S),

for some element e.

The search algorithm can be realized as a random walk on the space of system states guided by probabilities

Pr(T(e)|S), e∈ε. (1)

Note that this is a general description which contains deterministic algorithms on one side and completely random search on the other. The goal is to find an optimal distribution which allows the maximization of F(S) in the most efficient way possible.

Most likely there will be events that have probability zero given certain state S which can be determined using prior knowledge. For example, it is not desirable for a student to watch a video on integration if he or she does not know how to differentiate. Such restrictions can be imposed using graphs on elements.

The probabilities (1) can be learned by continuous monitoring of the student's behavior and evaluating the progress (i.e., values of the objective function F(S)). In the system training mode, a student is presented with the system being in an initial state (see below) with all transition probabilities being equal. The student can freely choose which events to trigger modulo restrictions imposed by the elements graph. Pairing sequences with the corresponding values of objective function F(S) can be used to devise optimal transitional probabilities.

The method of obtaining initial states will now be described. With S₀ defined as the state where Iₖ=0 and Aⱼ=“unknown”, the initial transitional probabilities Pr(T(e)|S₀) can be determined by relying on prior experience. Reasonable starting points to define such probabilities include:
1. Performing a placement test, i.e. setting the probabilities of a subset of assessment elements to non-zero values, or
2. Presenting a student with introductory material, i.e. setting the probabilities of a subset of information elements to non-zero values.

Measures of a student's behavior may contain time spent on a particular element, various counters, repetitions, content evaluation (i.e., “likes” or “don't likes”), etc. Note that behavioral patterns may contain information about certain classes of students. If these classes can be determined then this information can be factored into the computation of transition probabilities. This may be accomplished by the following equation where G is a random variable corresponding to a student's group and

Pr(Q|S)=Pr(T(e)|S,G).

Once the initial probability distribution is obtained, it can be used to guide new students to learn the material in the most efficient way possible and according to their group preferences. The optimal transition probabilities can be continuously re-evaluated using new data.

### EXAMPLE 1

The following example, as depicted in Example 1 and described as follows, will illustrate the use and benefits of the present invention. Assuming there are two users with the same set of mastered knowledge units that study differentiation. They have learned how to apply the product rule and the quotient rule and also know the derivatives of various elementary functions. By observing previous interactions with the system, the two users were classified according to their behavior as follows:
User 1: a fast pace learner that likes to quickly read text (i.e., slides) then watch a demonstration solution and proceed to solve problems.
User 2: a slow pace learner that begins by watching a video and usually watches the demonstration solution, uses a tutorial and then completes a large amount of problems.

With reference to Example 1, the possible sessions of the two users are described with a focus on the differences. The general workflow is that the users are presented with a sorted list of suggested actions that can be performed with the most appropriate actions positioned at the top. It will be obvious to one of ordinary skill in the art that the organization of this list can range from a simple menu to a complicated menu. It should be noted that unique choices are not forced on the user and it is possible to proceed with an arbitrary topic, including an out of site topic.

It should be understood that the embodiments described herein are merely exemplary in nature and that a person skilled in the art may make many variations and modifications thereto without departing from the scope of the present invention. All such variations and modifications, including those discussed above, are intended to be included within the scope of the invention.

Example 1 depicting a comparison of potential workflows of a Fast Pace Learning User and a Slow Pace Learning User is reproduced below:

Example 1

| Fast Pace Learning (User 1) | Slow Pace Learner (User 2) |
|---|---|
| User presented with a list of options: | User presented with a list of options: |
| 1. Next topic “Chain Rule” | 1. Next topic “Chain Rule” |
| 2. See also “Implicit Differentiation” | 2. Solve problems on “Product rule” |
| 3. See also “Linear Approximation” | 3. Solve problems on “Quotient Rule“ |
| 4. Solve problems on “Product rule” | 4. . . . |
| 5. Solve problems on “Quotient Rule“ | |
| 6. . . . | |
| User selects 1. Next topic “Chain Rule” | User selects 1. Next topic “Chain Rule” |
| User presented with a list of options: | User presented with a list of options: |
| 1. Read text | 1. Watch video |
| 2. Watch solution demo | 2. Read text |
| 3. Solve in tutor | 3. Watch solution demo |
| 4. Watch video | 4. Solve in tutor |
| 5. Solve problems | 5. Do exercise |
| 6. Take test | 6. Take test |
| 7. . . . | 7. . . . |
| User selects 1. Read text | User selects: 1. Watch video |
| Slide with a formal definition of the chain rule is | A video with detailed explanation of how the chain rule is |
| presented. | obtained is presented. |
| User completes the review. | User completes the review. |
| User presented with a list of options: | User presented with a list of options: |
| 1. Watch solution demo | 1. Read text |
| 2. Solve problems | 2. Watch solution demo |
| 3. Take test | 3. Solve in tutor |
| 4. Solve in tutor | 4. Solve problems |
| 5. Read text | 5. Watch video |
| 6. Watch video | 6. Take test |
| 7. . . . | 7. . . . |
| User selects 1. Watch solution demo | User selects 2. Watch solution demo |
| A short solution to a chain rule problem is | A very detailed solution to a chain rule problem is |
| presented: | presented: |
| (sin x²)′ = 2x cos x² | Let y = sin x² , h(x) = x² and g(h) = sin h then y = g(h(x)) |
| User completes the review | h′(x) = 2x |
| | g(h) = cos h = cos x², |
| | y′ = h′(x) g(h) = 2x cos x² |
| | User completes the review |
| User presented with a list of options: | User presented with a list of options: |
| 1. Solve problems | 1. Solve in tutor |
| 2. Take test | 2. Solve problems |
| 3. Solve in tutor | 3. Take test |
| 4. Watch solution demo | 4. Watch solution demo |
| 5. Watch video | 5. Watch video |
| 6. Read text | 6. Read text |
| 7. . . . | 7. . . . |
| User selects 1. Solve problems | User selects 1. Solve problems |
| A problem presented tot he user: | Interactive tutor walks users through the problem (Text in |
| Compute the derivative of | bold is the user input): |
| y = ln(sin x + x²) | y= ln(sin x + x²) = g(h(x)) |
| User enters: | h(x) = sin x + x² |
| y′ = (cos x + x)/(sin x + x²) | g(h) = ln(h) |
| (Note the derivative is incorrect because the | h′(x) = cos x + x |
| derivative of x² was entered incorrectly) | g′(h) = 1/h = 1/(sin x + x²) |
| User completes solution | y′ = (cos x + x)/(sin x + x²) |
| | Note the derivative h′(x) is incorrect because the |
| | derivative of x² was entered incorrectly. The tutor will |
| | immediately point out the mistake and suggest to review |
| | “Derivatives of the Polynomials” |
| | User corrects the mistake and completes the review |
| User presented with a list of options: | User presented with a list of options: |
| 1. Review “Derivatives of Polynomials” | 1. Solve problems |
| 2. Solve problems | 2. Review “Derivatives of Polynomials” |
| 3. Solve in Tutor | 3. Solve in tutor |
| 4. Take test | 4. Take test |
| 5. . . . | 5. . . . |
| User takes the review and solves another similar | User solves another similar problems correctly |
| problem correctly | |
| User presented with a list of options: | User presented with a list of options: |
| 1. Take test | 1. Solve more problems |
| 2. Solve problems | 2. Take test |
| 3. Solve in tutor | 3. Solve in tutor |
| 4. . . . | 4. . . . |
| User selects “1. Take test” and performs with a | User selects “2. Take test” and performs with a passing |
| passing grade | grade |
| User presented with a list of options: | User presented with a list of options: |
| 1. Review the test | 1. Review the test |
| 2. Next topic “Implicit differentiation” | 2. Next topic “Implicit differentiation” |
| 3. See also “Linear approximation” | 3. Solve more problems |
| 4. solve more problems | 4. . . . |
| 5. . . . | |

We claim:

1. A method for providing an adaptive learning environment to a person, comprising:
providing a database of knowledge content elements;
interlinking the content elements, forming a traversable data structure;
presenting at least one of the content elements to the person, thereby defining an informative element; and
recording the presentation of the informative element to the person, thereby creating a record of informative elements that the person has been exposed to.

2. The method of claim 1, wherein the traversable data structure may be modeled by a directed graph.

3. The method of claim 2, wherein an order of presentation during the step of presenting is determined by at least a portion of the directed graph.

4. The method of claim 1, wherein the interlinked content elements include assessment elements that may be presented to the person in a problem/solution relationship, whereby traversal of a given set of assessment elements may test the knowledge of the person.

5. The method of claim 3, further comprising the steps of assessing the assimilation of the informative element presented to the person by the person by presenting at least one assessment element and recording the assessment element presented and a response by the person thereto.

6. The method of claim 5, wherein the person's response is assessed as accurate or not and the assessment recorded to provide insight into the progress of the person in assimilating knowledge presented.

7. The method of claim 5, wherein the person's responses are evaluated for accuracy and further comprising the step of presenting content elements to the person responsive to the assessment and in the case of inaccurate responses, presenting remedial content elements.

8. The method of claim 1, wherein the knowledge content elements are derived from at least one of documents, videos or images.

9. The method of claim 8, wherein the content elements are at least one of a video, a portion of a video, a paragraph, a sentence, a formula, a definition, an image, a portion of an image, a step in a solution of a problem or an instant response question.

10. The method of claim 6, wherein outcomes of the assessment elements are a numerical score.

11. The method of claim 6, wherein outcomes of the assessment elements are categorical.

12. The method of claim 6, wherein outcomes of the assessment elements include the assessment “unknown” to indicate that an assessment element has not been triggered yet.

13. The method of claim 1, wherein the method is implemented on a programmable computer system with digital storage for storing the database of knowledge elements, a processor for executing the steps of the method and input and output devices supporting communication between the person and the system and wherein I={i₁, . . . , iₙ} is the set of all information elements and A={a₁, . . . , aₘ} the set of all assessment elements and a state of the system is the set S, S={I₁, . . . , Iₙ, A₁, . . . , Aₘ}, where Iₖ is the number of times an information element iₖ was observed during a run of the system and Aⱼ is the value of the outcome of a particular assessment element and wherein every time a value of an element of S is changed, the system makes a transition into another state, which may have previously been observed, given a particular state S of a system run, an objective function F(S)≧0 may be defined which corresponds to the progress of a student (i.e., an amount of knowledge or mastered subjects).

14. The method of claim 13, further comprising the steps of maximizing F(S) probabilistically by defining T(e) as the event that an element e∈ε=IU A triggers, assuming it is impossible to execute two or more events simultaneously implying that the movement from state S to another state Q can be accomplished by triggering only one event T(e) and, therefore, the transition probability is Pr(Q|S)=Pr(T(e)|S), for some element e; executing a random walk search algorithm on the space of system states guided by probabilities Pr(T(e)|S), e∈ε to find an optimal distribution which allows the maximization of F(S) in the most efficient way possible.

15. The method of claim 13 wherein F(S) is determined by summing normalized outcomes of the assessment elements.

16. The method of claim 13, further comprising the step of obtaining an initial state for the system by performing a placement test.

17. The method of claim 13, further comprising the step of obtaining an initial state for the system by setting the probabilities of a subset of information elements to non-zero values.

18. The method of claim 1, further comprising the step of observing the interaction of a plurality of persons to ascertain behavioral patterns and using the behavioral patterns to guide the presentation of content elements.

19. The method of claim 18, further comprising the step of ascertaining groups of like persons based upon a similarity in behavior patterns and using group behavior patterns to guide the presentation of content elements.

20. A computer readable media having digital information thereon suitable for programming a computer to perform the method of claim 1.
